(19) United States
(12) Patent Application Publication
(10) Pub. No.: US 2016/0291949 A1
(43) Pub. Date: Oct. 6, 2016

(54) PARALLELIZATION COMPILING METHOD, PARALLELIZATION COMPILER, AND VEHICULAR DEVICE

(71) Applicants: DENSO CORPORATION, Kariya-city (JP); WASEDA UNIVERSITY, Tokyo (JP)

(72) Inventors: Kenichi MINEDA, Kariya-city (JP); Noriyuki SUZUKI, Kariya-city (JP); Hironori KASAHARA, Tokyo (JP); Keiji KIMURA, Tokyo (JP); Hiroki MIKAMI, Tokyo (JP); Dan UMEDA, Tokyo (JP)

(21) Appl. No.: 15/083,592

(22) Filed: Mar. 29, 2016

(30) Foreign Application Priority Data
Mar. 31, 2015 (JP) 2015-72814

(51) Int. Cl. G06F 9/45

(52) U.S. Cl. CPC G06F 8/451

(57) ABSTRACT

A parallelization compiling method includes analyzing a sequential program prepared for a single-core processor; dividing the sequential program into a plurality of processes based on an analysis result; and generating a parallelized program, which is subjected to a parallelized execution by a multi-core processor, from the plurality of processes. The generating of the parallelized program includes compiling the plurality of processes under an execution order restriction defined based on a predetermined parameter.

### CROSS REFERENCE TO RELATED APPLICATION

This application is based on Japanese Patent Application No. 2015-072814 filed on Mar. 31 2015, the disclosure of which is incorporated herein by reference.

### TECHNICAL FIELD

The present disclosure relates to a parallelization compiling method, a parallelization compiler, and a vehicular device.

### BACKGROUND

With the mounting of a multi-core processor on a vehicular device, programs can be distributed to respective cores, and therefore throughput can be improved. In the vehicular device on which the multi-core processor is mounted, a sequential program designed for a conventional single-core processor program needs to be replaced with a parallelized program with which parallelizing process can be executed by the multi-core processor. Up to now, in order to facilitate the generation of the parallelized program, a parallelization compiler that automatically generates the parallelized program from the sequential program has been proposed. As the parallelization compiler of this type, a parallelization compiler disclosed in JP 2015-001807 A (corresponding to US 2014/0372995 A1) has been proposed. The parallelization compiler disclosed in JP 2015-001807 analyzes a data dependency and a control dependency between processes included in the sequential program, and automatically generates the parallelized program from the sequential program on the basis of an analysis result.

Meanwhile, for example, when a part of the processing in the sequential program is changed due to version upgrade, there is a possibility to change a data dependency and a control dependency between the processes configuring the sequential program. For that reason, when the changed sequential program is compiled by the parallelization compiler without any action, an execution order of the parallelized program of not only a changed portion but also the other portions may be remarkably replaced with each other. In other words, a small change of the sequential program is likely to spread to a change in the overall parallelized programs. In that case, because there is a need to verify again whether the overall parallelized program is normal or not, the verification cost of the parallelized program may be increased.

### SUMMARY

In view of the foregoing difficulties, it is an object of the present disclosure to provide a parallelization compiling method, a parallelization compiler, and a vehicular device each of which is capable of easily verifying a parallelized program when a modification or change is made in a program.

According to a first aspect of the present disclosure, a parallelization compiling method includes analyzing a sequential program prepared for a single-core processor; dividing the sequential program into a plurality of processes based on an analysis result; and generating a parallelized program, which is subjected to a parallelized execution by a multi-core processor, from the plurality of processes. The generating of the parallelized program includes compiling the plurality of processes under an execution order restriction defined based on a predetermined parameter.

According to a second aspect of the present disclosure, a parallelization compiler, which is stored in a non-transitory tangible computer readable storage medium as a program product, includes instructions to be executed by a compiling device. The instructions are for implementing analyzing a sequential program prepared for a single-core processor; dividing the sequential program into a plurality of processes based on an analysis result; and generating a parallelized program, which is subjected to a parallelized execution by a multi-core processor, from the plurality of processes. The generating of the parallelized program includes compiling the plurality of processes under an execution order restriction defined based on a predetermined parameter.

According to a third aspect of the present disclosure, a vehicular device includes multi-core processor performing a control process based on the parallelized program generated by the parallelization compiling method according to the first aspect of the present disclosure.

According to a fourth aspect of the present disclosure, a vehicular device includes a multi-core processor performing a control process based on the parallelized program generated by the parallelization compiler according to the second aspect of the present disclosure.

With the above parallelization compiling method, parallelization compiler, and vehicular device, when a modification or change is made to a parallelized program, verification of the parallelized program can be carried out in an easy and effective manner.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating a schematic configuration of a compiling device in which a parallelization compiler is installed according to a first embodiment of the present disclosure;

FIG. 2 is a block diagram illustrating a schematic configuration of the compiling device and an electronic control unit (ECU) according to the first embodiment;

FIG. 3 is a diagram illustrating a processing procedure executed by the parallelization compiler according to the first embodiment;

FIG. 4 is a diagram schematically illustrating an example of a method of dividing a sequential program in the parallelization compiler according to the first embodiment;

FIG. 5 is a diagram schematically illustrating a dependency of processes in the parallelization compiler according to the first embodiment;

FIG. 6 is a diagram schematically illustrating an example of scheduling in the parallelization compiler according to the first embodiment;

FIG. 7 is a diagram illustrating a processing procedure executed by a parallelization compiler according to a second embodiment of the present disclosure;

FIG. 8 is a diagram schematically illustrating a dependency of processes in the parallelization compiler according to the second embodiment;

FIG. 9 is a diagram illustrating a processing procedure executed by a parallelization compiler according to a third embodiment of the present disclosure;

FIG. 10 is a diagram schematically illustrating an example of a sequential program in the parallelization compiler according to the third embodiment;

FIG. 11 is a diagram schematically illustrating an example of scheduling in the parallelization compiler according to the third embodiment;

FIG. 12 is a diagram illustrating a processing procedure executed by a parallelization compiler according to a fourth embodiment of the present disclosure;

FIG. 13 is a diagram schematically illustrating an example of a sequential program in the parallelization compiler according to the fourth embodiment;

FIG. 14 is a diagram illustrating a processing procedure executed by a parallelization compiler according to a fifth embodiment of the present disclosure;

FIG. 15 is a diagram schematically illustrating an example of scheduling in the parallelization compiler according to the fifth embodiment;

FIG. 16 is a diagram illustrating a processing procedure executed by a parallelization compiler according to a sixth embodiment of the present disclosure;

FIG. 17 is a diagram schematically illustrating an example of scheduling in the parallelization compiler according to the sixth embodiment; and

FIG. 18 is a diagram schematically illustrating an example of scheduling in a parallelization compiler according to another embodiment of the present disclosure.

### DETAILED DESCRIPTION

### First Embodiment

The following will describe a parallelization compiling method, a parallelization compiler, and a vehicular device according to a first embodiment with reference to the drawings.

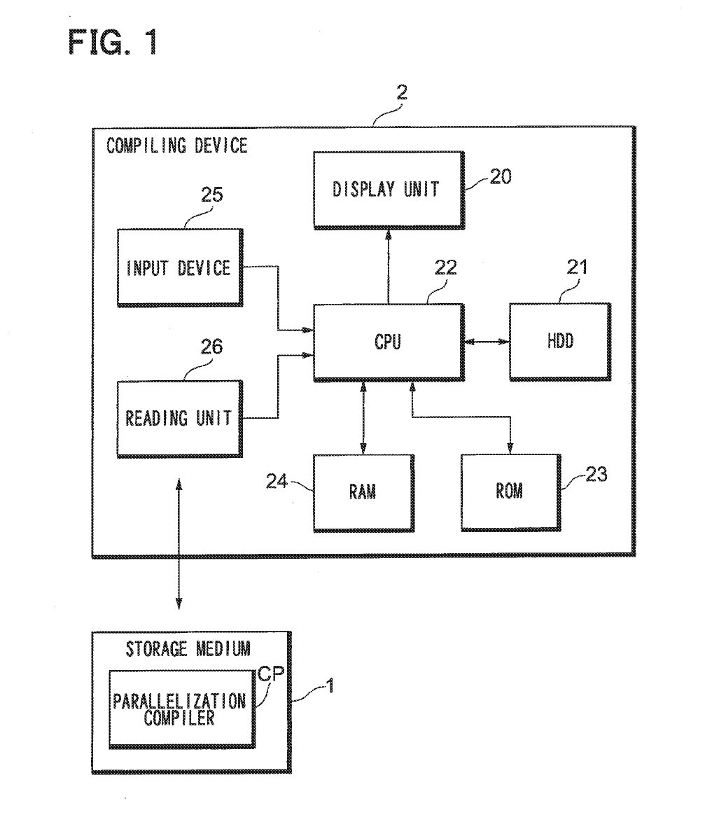

As illustrated in FIG. 1, a parallelization compiler CP according to the present embodiment is provided to a user in a state being stored in a storage medium 1.

The parallelization compiler CP generates a multi-core processor source program for a built-in system from a single-core processor source program for a built-in system. Hereinafter, the single-core processor program is called “sequential program”. The multi-core processor source program is called “parallelized program”.

The storage medium 1 may be provided by an optical disk, a magnetic disk, or a semiconductor memory such as a Digital Versatile Disc (DVD), a Compact Disc Read-Only Memory (CD-ROM), a Universal Serial Bus (USB) memory, or a memory card (registered trademark). The parallelization compiler CP stored in the storage medium 1 is installed into a compiling device 2.

The compiling device 2 is used for the development of the parallelized program for a built-in system of the vehicular device. The compiling device 2 includes a display unit 20, a hard disk drive (HDD) 21, a central processing unit (CPU) 22, a read-only memory (ROM) 23, a random access memory (RAM) 24, an input device 25, and a reading unit 26.

The display unit 20 displays an image based on an image signal output from the CPU 22.

The input device 25 includes a keyboard and a mouse. The input device 25 outputs a signal corresponding to user's operation to the CPU 22.

The reading unit 26 reads out the parallelization compiler CP from the storage medium 1.

The RAM 24 is used as a storage area for temporarily storing a program and a storage area for temporarily storing calculation processing data when the CPU 22 executes the program stored in the ROM 23 or the HDD 21.

The CPU 22 reads out an operating system (OS) from the HDD 21, and executes the operating system, to thereby execute various programs stored in the HDD 21 as a process on the OS. The CPU 22, for example, receives an input of a signal from the input device 25, controls an output of an image signal to the display unit 20, and reads out data from the RAM 24 and the HDD 21 or writes data into the RAM 24 and the HDD 21 in this process.

The parallelization compiler CP, which is read out from the storage medium 1 by the reading unit 26, is installed into the compiling device 2. The installed parallelization compiler CP is stored in the HDD 21, and functions as one of the applications executed as a process on the OS.

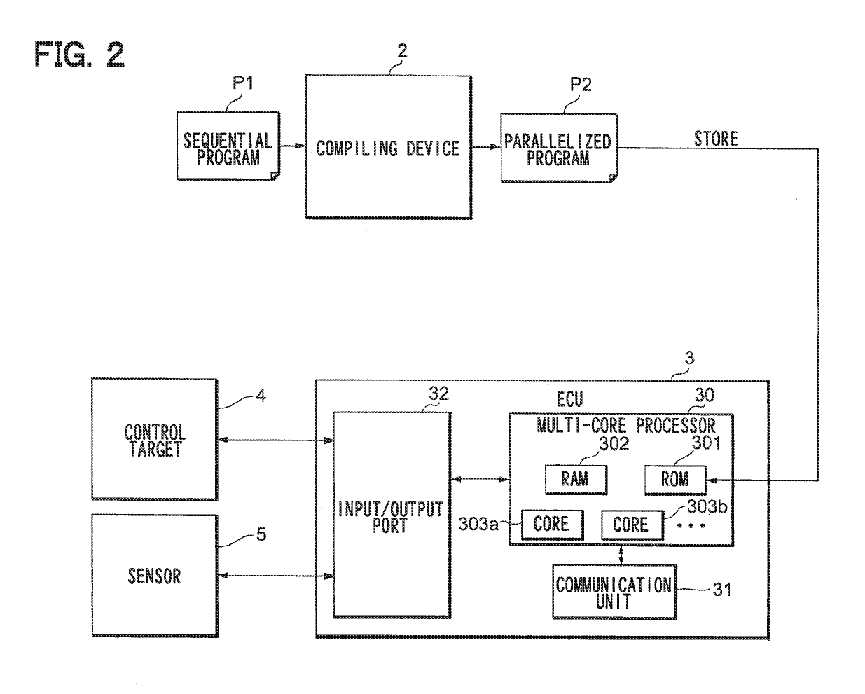

In the compiling device 2, the parallelization compiler CP executes a parallelizing process in response to a user's instruction. As illustrated in FIG. 2, the parallelizing process is a process for automatically generating a parallelized program P2 from a sequential program P1. The parallelized program P2 generated by the compiling device 2 is stored in electrical control unit (ECU) 3. The ECU 3 includes a multi-core processor 30, a communication unit 31, and an input/output port 32. In the present embodiment, the ECU 3 corresponds to the vehicular device.

The input/output port 32 captures detection signals from various sensors 5 mounted in a vehicle, and transmits a control signal to a control target 4 such as a vehicle actuator. The driving of the control target 4 is controlled according to the control signal transmitted from the ECU 3 to the control target 4.

The multi-core processor 30 includes a ROM 301, a RAM 302, multiple cores 303a, 303b and so on. Binary data of the parallelized program P2 generated by the compiling device 2 is stored in the ROM 301. The multi-core processor 30 operates on the basis of the parallelized program P2 stored in the ROM 301, and comprehensively controls the driving of the control target 4.

The communication unit 31 is configured to communicate with another in-vehicle ECU connected to the communication unit 31 through an in-vehicle network such as a controller area network (CAN, registered trademark).

The following will describe a process of generating the parallelized program P2 from the sequential program P1 by the parallelization compiler CP in detail.

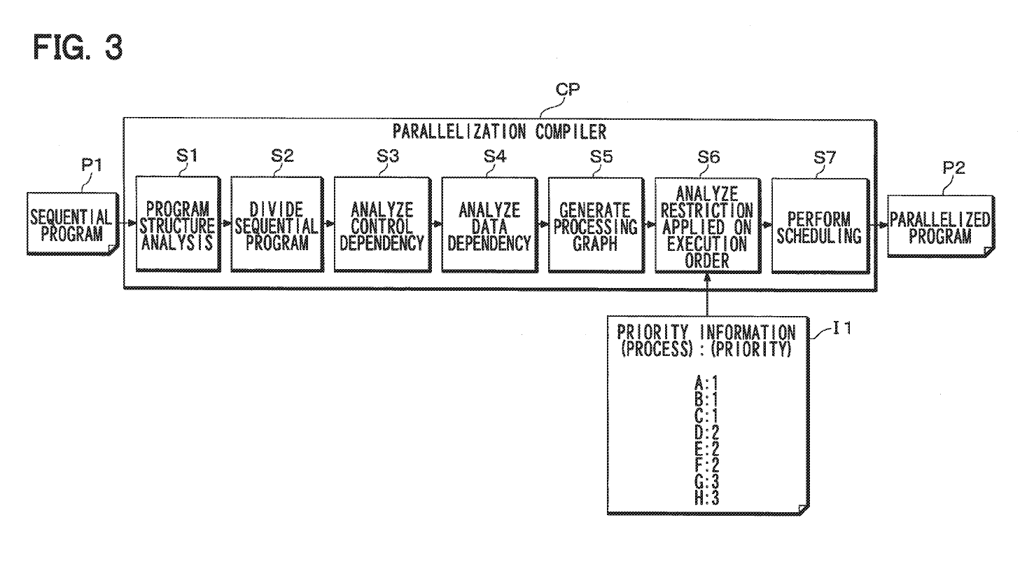

As illustrated in FIG. 3, the parallelization compiler CP first analyzes a program structure of the sequential program P1 at S1. Specifically, the parallelization compiler CP performs, for example, a lexical analysis and a syntactic/semantic analysis of the sequential program P1.

In this situation, the parallelization compiler CP performs an inline expansion on the sequential program P1. The inline expansion is a process for replacing a description for calling a subroutine in the program with a description of a process defined in the subroutine. Because a built-in system program is generally fine in process, the parallelization with coarse granularity is difficult. However, by performing the inline expansion, a parallelism in the subroutine can be effectively used.

In addition, the parallelization compiler CP identifies, in each function block of the sequential program P1, process blocks each of which uses a local variable having the same name. The parallelization compiler CP also modifies the sequential program P1 so that a local variable having individual name is used in each of the identified processing blocks. Each process block is, for example, an aggregation of the descriptions of statements of loop processing and branch processing such as an if-statement or a switch-case statement, and assignment statements associated with the statements.

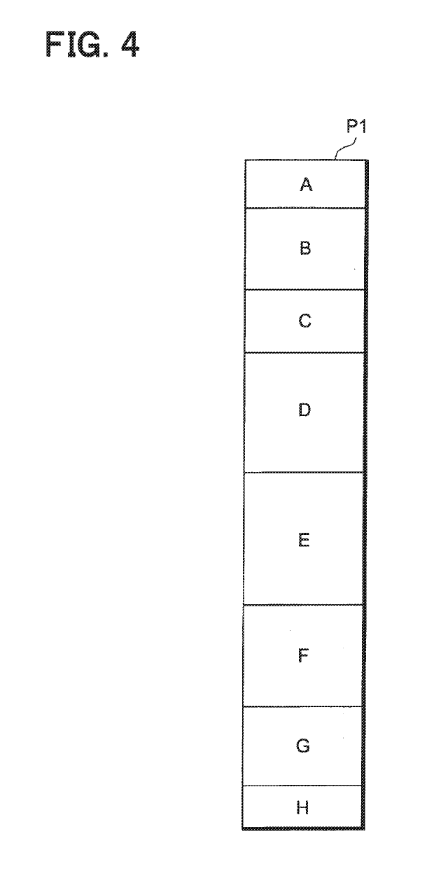

At S2, the parallelization compiler CP divides the sequential program P1 into multiple processes (macro tasks) A, B and so on, on the basis of the lexicon, syntactic/semantics, or the like, which is analyzed in S1. The respective processes A, B and so on are a series of processes including, for example, various calculating, assigning, and branching processes, and function calls. For example, as illustrated in FIG. 4, the parallelization compiler CP branches the sequential program P1 into processes A to H.

As illustrated in FIG. 3, subsequent to S2, the parallelization compiler CP analyzes a control dependency among the respective processes A, B and so on at step S3, and analyzes a data dependency among the respective processes A, B and so on at S4). At S5, the parallelization compiler CP generates a processing graph (macro task graph) MTG on the basis of the data dependency and the control dependency among the respective processes A, B and so on. The parallelization compiler CP generates the processing graph MTG, for example, on the basis of the following conditions A1 and A2.

Condition A1: When the process x is data-dependent on the process y, the process y cannot be executed until the execution of the process x is completed.

Condition A2: When a condition branch destination of the process y is determined, the process x control-depending on the process y can be executed even if the execution of the process y is not completed.

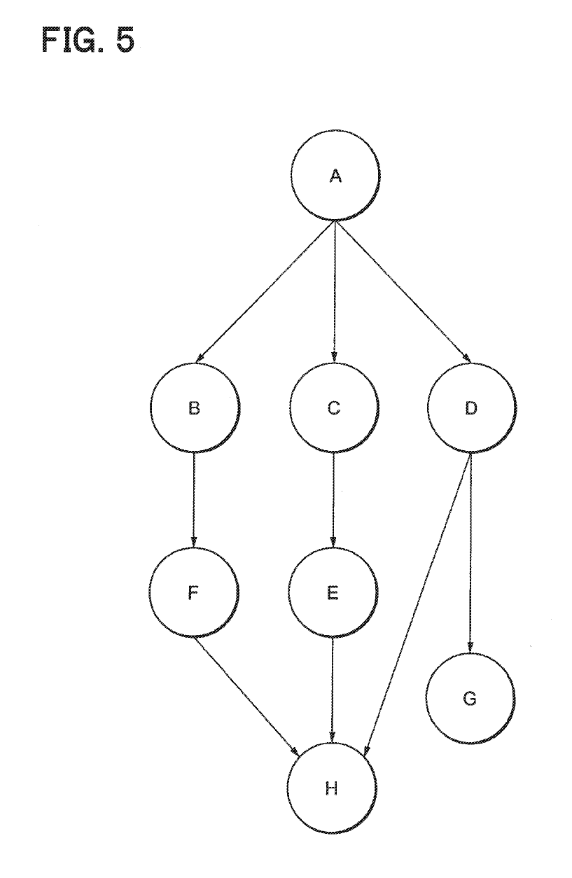

In the processing graph MTG, the data dependency of all the processes included in the sequential program P1 is represented. For example, the parallelization compiler CP generates the processing graph MTG as illustrated in FIG. 5 from the processes A to H included in the sequential program P1 as illustrated in FIG. 4.

Subsequent to S5, the parallelization compiler CP, at S6, analyzes the restriction applied on the execution order of the respective processes A, B and so on, on the basis of process priority information I1 including priority information of each process included in the sequential program P1. The process priority information I1 is preliminarily determined to represent, for example, priorities of the process units A, B, which are illustrated in FIGS. 4 and 5, by respective numerals. In the process priority information I1, a smaller numeral represents a higher execution priority of the process. The processes having priority information of identical numerals represent no difference in the priority of the execution order. The priority information I1 may be, for example, transmitted from the input device 25 as input information, or may be stored in the storage medium 1 in advance. In the present embodiment, the priority information I1 corresponds to a predetermined parameter.

Subsequent to the process in S6, the parallelization compiler CP, at S7, performs scheduling for assigning the respective processes A, B and so on to multiple process groups PG1, PG2 and so on, on the basis of the processing graph MTG generated in S5, and the restriction applied on the execution order of the respective processes A, B and so on analyzed in S6. The number of process groups PG1, PG2 and so on corresponds to the number of cores 303a, 303b and so on of the multi-core processor 30. For example, when the number of cores provided in the multi-core processor 30 is two, two process groups are provided. Specifically, the parallelization compiler CP allocates all or a part of the processes executable in the parallelizing process to different process groups while satisfying the following conditions B1 and B2.

Condition B1: The process having higher priority is executed prior to the process having lower priority.

Condition B2: A start time of the process having lower priority is posterior to an end time of the process having higher priority.

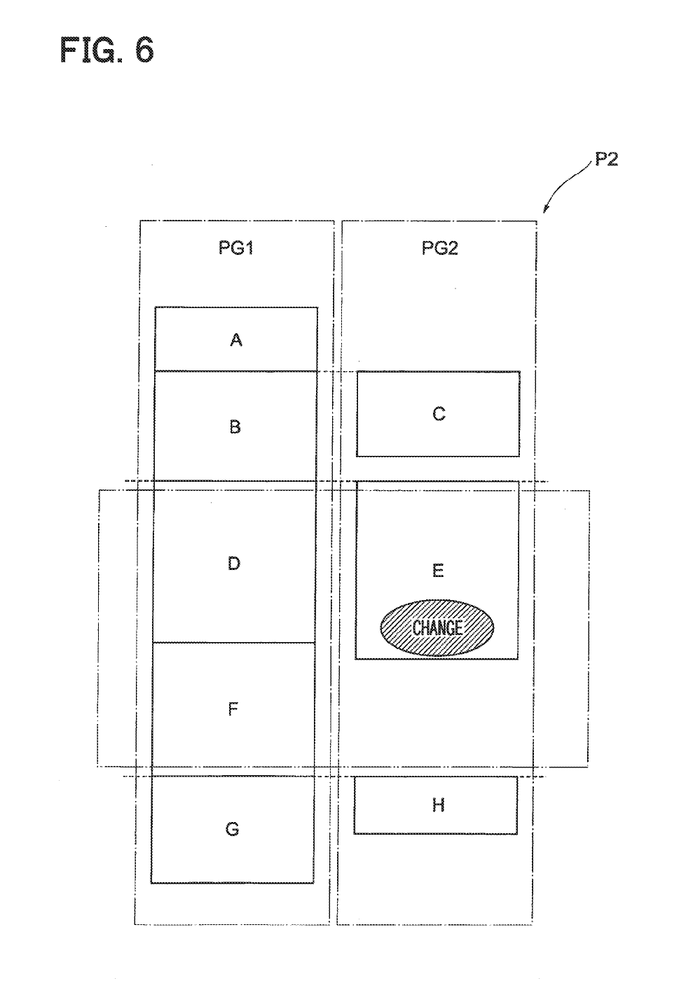

The parallelization compiler CP inserts a waiting duration into the process groups PG1, PG2 and so on for satisfying the above-described conditions as necessary. As a result, the parallelization compiler CP generates the process groups PG1 and PG2 illustrated in FIG. 6, for example, on the basis of the processing graph MTG illustrated in FIG. 5 and the priority information I1.

The parallelization compiler CP may generate multiple comparative example sets of the process groups PG1, PG2 and so on, and select a set of optimum process groups PG1, PG2 and so on from the multiple comparative example sets. The determination of whether one set of the process groups PG1, PG2 and so on is optimum or not, is performed, for example, with the use of the respective lengths of execution durations of the multiple sets of process groups PG1, PG2 and so on, and evaluation values calculated on the basis of a predetermined evaluation function.

After the generation of the process groups PG1, PG2 and so on has been completed, the parallelization compiler CP generates binary data of the parallelized program P2 on the basis of the process groups PG1, PG2, and so on. The parallelized program P2 generated as described above is stored in the ROM 301 of the multi-core processor 30.

The following will describe the operation and advantages of the parallelization compiling method, the parallelization compiler CP, and the ECU 3 according to the present embodiment.

As illustrated in FIG. 6, it is assumed that, for example, the contents of the process E are changed with a change in the sequential program P1 caused by version upgrade or the like and the processes D, E, and F have the same priority. In that case, when the parallelization compiler CP generates the parallelized program P2 from the sequential program P1, the assignment of the processes D, E, and F to the process groups PG1 and PG2 may be changed caused by the change in the process E. However, the assignment of the processes A to C, G, and H except for the processes D to F to the process groups PG1 and PG2 is maintained without change. In other words, the change in the process E merely affects a local extent of the parallelized program indicated by a two-dot chain line in the FIG. 6 without affecting the overall parallelized program P2. As described above, since only a local extent of the parallelized program P2, specifically, the processes D to F need to be verified, the verification of the parallelized program P2 can be carried out in an easy and effective manner.

In some cases, a program specification has provisions of the execution order on a function basis. When the allocation of the processes to the process groups is performed with consideration of only data dependency of the processing graph MTG, the specifications of the processes assigned to the process groups PG1, PG2 and so on may mismatch with one another. In other words, there is a possibility that the specifications of the processes included in the parallelized program P2 mismatch with one another. According to the parallelization compiler CP of the present embodiment, by setting the priority information I1 according to the specification of each process, the mismatch of the specifications of processes in the parallelized program P2 can be avoided in a case where, for example, the process E is changed.

### Second Embodiment

The following will describe a parallelization compiling method, a parallelization compiler CP, and an ECU 3 according to a second embodiment according to a second embodiment. Hereinafter, differences from the first embodiment will be mainly described.

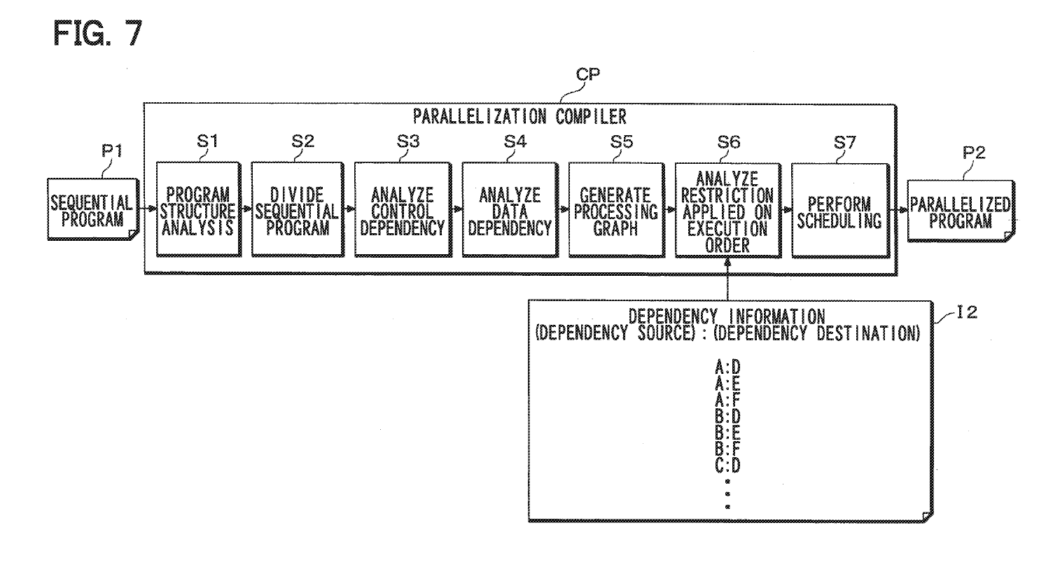

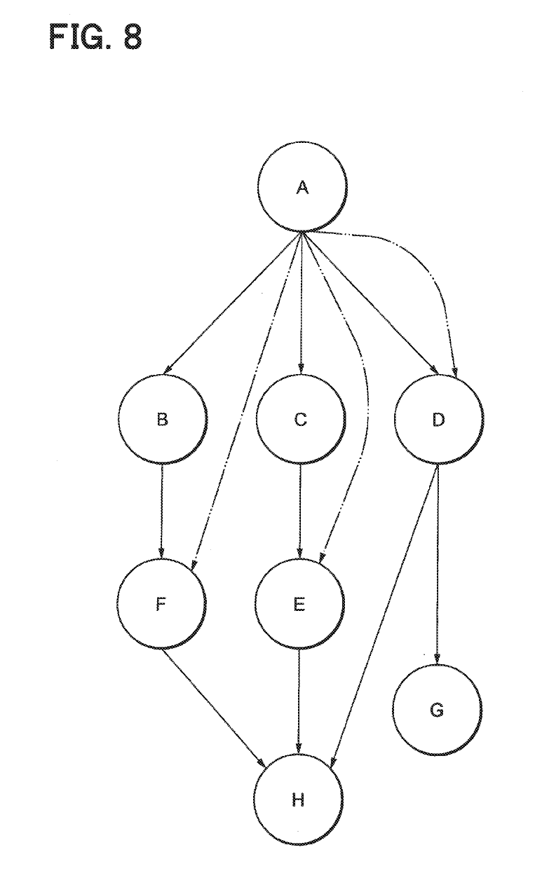

As illustrated in FIG. 7, at S6, the parallelization compiler CP according to the present embodiment analyzes the restriction applied on an execution order of respective processes A, B and so on, on the basis of dependency information I2, instead of priority information I1 of the processes. The dependency information 12 represents an arbitrarily settable data dependency of the processes A, B and so on. The dependency information I2 is different from the data dependency of processes defined in the processing graph MTG. The dependency information I2 represents the data dependency of the respective processes A, B and so on, for example, as illustrated in FIG. 8. The dependency information I2 represents a data dependency between a process described in a column of a dependency source and a process described in a column of a dependency destination. For example, the dependency information I2 represents that the process A has the data dependency on the processes D to F. The dependency information I2 may be, for example, transmitted from the input device 25 as input information, or may be stored in the storage medium 1 in advance. In the present embodiment, the dependency information I2 corresponds to a predetermined parameter. As a result, for example, a hypothetical data dependency as indicated by a two-dot chain line in FIG. 8 can be added to the process A. In FIG. 8, for convenience, only the hypothetical data dependency of the process A is illustrated. At S7, the parallelization compiler CP performs scheduling for assigning the respective processes A, B and so on to multiple process groups PG1, PG2 and so on, on the basis of the processing graph MTG generated in S5 and the restriction applied on the execution order of the respective processes A, B and so on, which are analyzed in S6. In this situation, the parallelization compiler CP performs scheduling without using the above-described conditions B1 and B2. In other words, the parallelization compiler CP assigns all or a part of the parallel executable processes to different process groups PG1 and PG2 on the basis of the processing graph MTG to which, for example, the hypothetical data dependency illustrated in FIG. 8 is added. As a result, the parallelization compiler CP assigns the processes to the process groups PG1 and PG2 so that the processes D to F are executed after the execution of the processes A to C has been completed. The parallelization compiler CP assigns the processes to the process groups PG1 and PG2 so that the processes G and H are executed after the execution of the processes D to F has been completed. Hence, the parallelization compiler CP generates the process groups PG1 and PG2, for example, as illustrated in FIG. 6.

The following will describe the operation and advantages of the parallelization compiling method, the parallelization compiler CP, and the ECU 3 according to the present embodiment.

As illustrated in FIG. 6, even when the contents of the process E are changed, the parallelization compiler CP generates the process groups PG1 and PG2 that allow the processes D to F to be executed after the execution of the processes A to C has been completed by the aid of the dependency information I2. The parallelization compiler CP generates the process groups PG1 and PG2 that allow the processes G and H to be executed after the execution of the processes D to F has been completed. Therefore, the change in the process E merely affects a region surrounded by a two-dot chain line in FIG. 6, that is, a local extent of a parallelized program P2. Hence, similar advantages as those in the first embodiment can be obtained by the configuration according to the second embodiment.

### Third Embodiment

The following will describe a parallelization compiling method, a parallelization compiler CP, and an ECU 3 according to a third embodiment. Hereinafter, differences from the first embodiment will be mainly described.

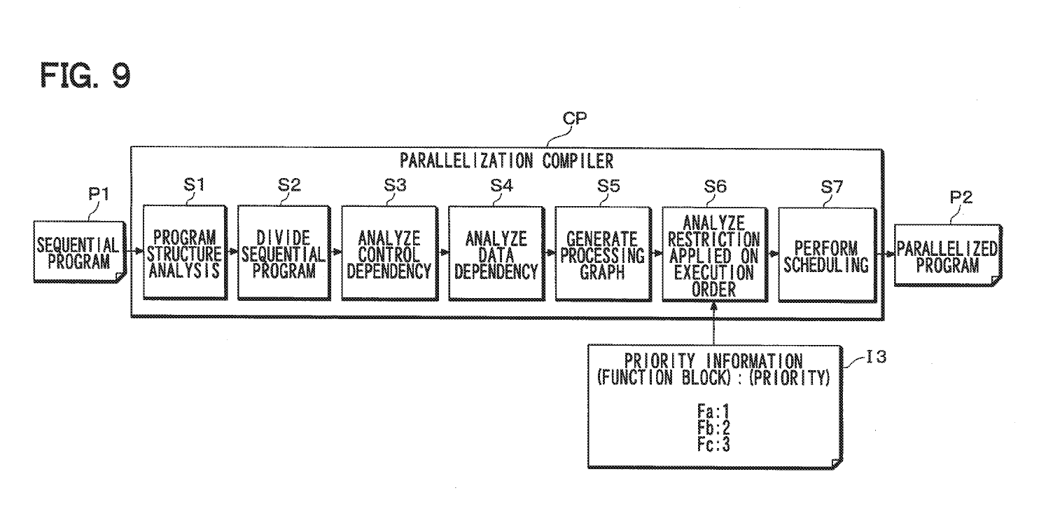

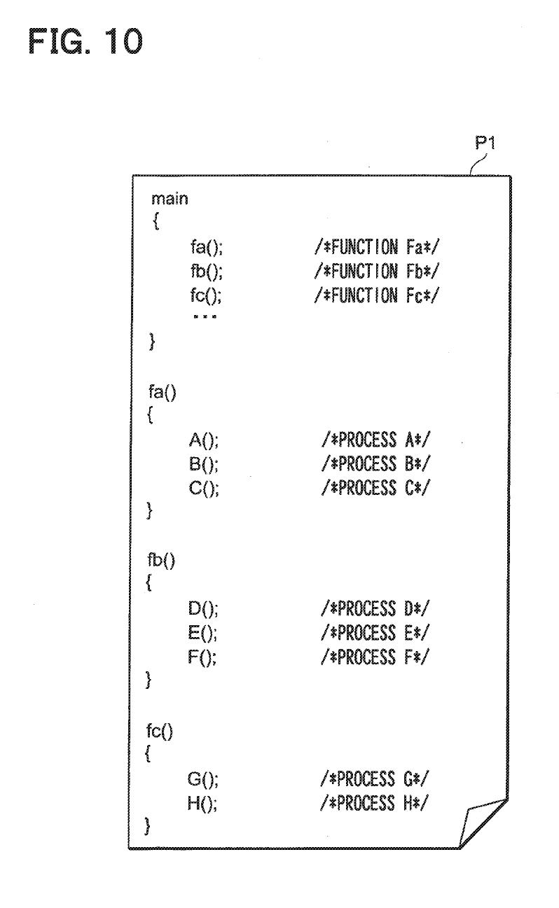

As illustrated in FIG. 9, the parallelization compiler CP according to the present embodiment analyzes, at S6, the restriction applied on an execution order of respective processes A, B and so on, on the basis of priority information I3 of the functions Fa, Fb and so on included in the sequential program P1, instead of the priority information I1 of the processes included in the sequential program. It is assumed that the functions Fa, Fb, and Fc, for example, as illustrated in FIG. 10 are described in the sequential program P1. The function Fa includes the processes A to C. The function Fb includes the processes D to F. The function Fc includes the processes G and H. At the time of inline expansion of a program structure analysis in S1, the processes A to H succeed to an execution order of a parent function as it is.

As illustrated in FIG. 9, the priority information I3 represents the priorities of respective functions Fa to Fc by numerals. In the priority information I3, a smaller numeral indicates a higher execution priority of the function. The priority information I3 may be, for example, transmitted from the input device 25 as input information, or may be stored in the storage medium 1 in advance. In the present embodiment, the priority information I3 corresponds to a predetermined parameter.

Subsequent to the process in S6, the parallelization compiler CP performs, at S7, scheduling for assigning the respective processes A, B and so on to multiple process groups PG1, PG2 and so on, on the basis of the processing graph MTG generated in S5 and the restriction applied on the execution order of the respective processes A, B and so on which are analyzed in S6. Specifically, the parallelization compiler CP allocates all or a part of the processes executable in the parallelizing process to different process groups PG1, PG2 and so on while satisfying the following conditions C1 and C2.

Condition C1: The function having higher priority is executed prior to the function having lower priority.

Condition C2: A start time of the function having lower priority is posterior to an end time of the function having higher priority.

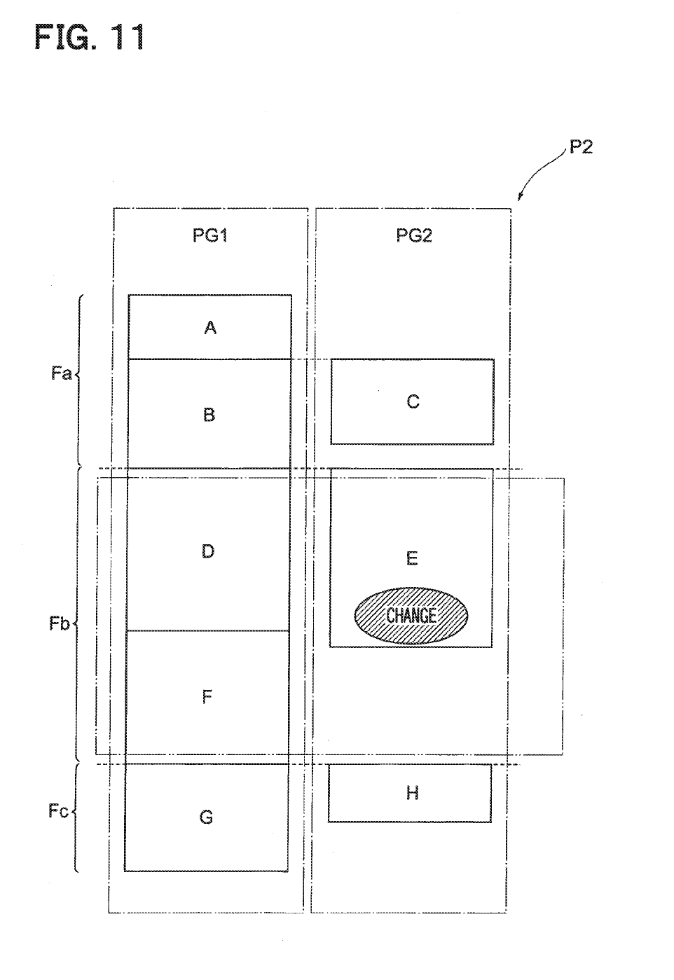

As a result, the parallelization compiler CP generates the process groups PG1 and PG2 illustrated in FIG. 11, for example, on the basis of the processing graph MTG illustrated in FIG. 5 and the priority information I3.

The following will describe the operation and advantages of the parallelization compiling method, the parallelization compiler CP, and the ECU 3 according to the present embodiment.

As illustrated in FIG. 11, even when the contents of the process E are changed, the parallelization compiler CP generates the process groups PG1 and PG2 that allow the function Fb to be executed after the execution of the function Fa has been completed by the aid of the priority information I3. The parallelization compiler CP generates the process groups PG1 and PG2 that allow the function Fc to be executed after the execution of the function Fb has been completed. Therefore, the change in the process E merely affects a region indicated by a two-dot chain line in FIG. 11, that is, a local extent of a parallelized program P2. Hence, similar advantages as those in the first embodiment can be obtained.

### Fourth Embodiment

The following will describe a parallelization compiling method, a parallelization compiler CP, and an ECU 3 according to a fourth embodiment. Hereinafter, differences from the first embodiment will be mainly described.

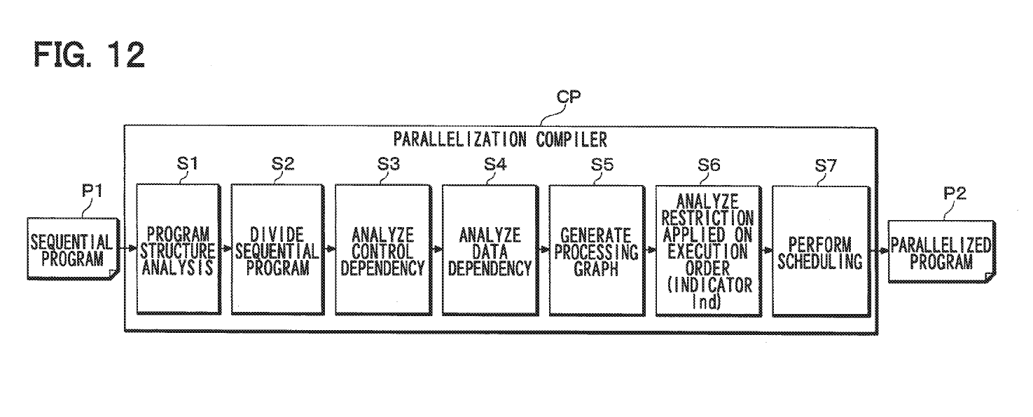

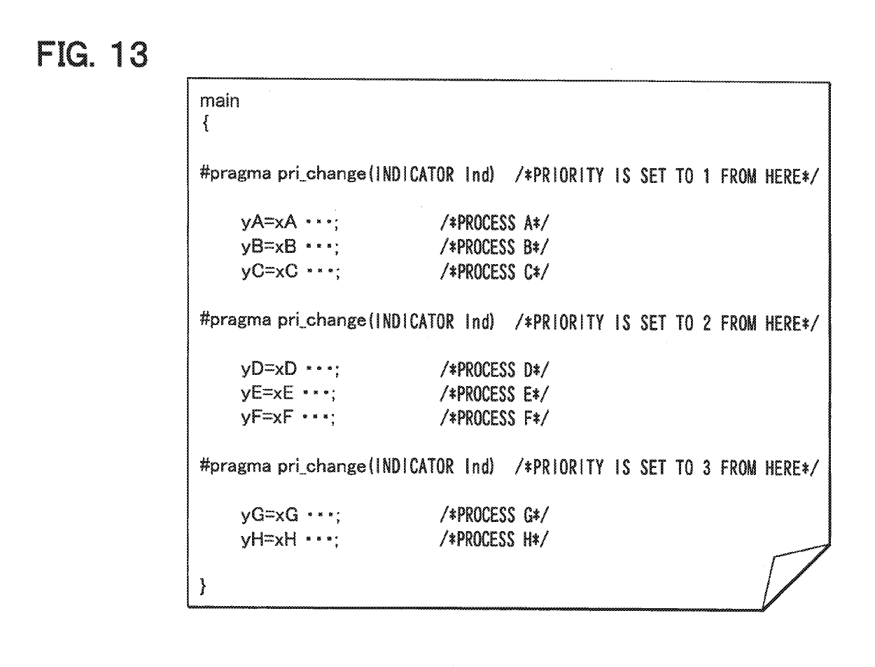

As illustrated in FIG. 12, the parallelization compiler CP according to the present embodiment analyzes, at S6, the restriction applied on an execution order of respective processes A, B and so on, on the basis of an indicator Ind described in a sequential program P1. The indicator Ind changes the priority of prior and posterior processes in the sequential program P1. For example, as illustrated in FIG. 13, it is assumed that the indicators Ind for changing the priority of the prior and posterior processes are described in the sequential program P1. In that case, the parallelization compiler CP decreases the priority of the execution order every time the indicator Ind appears in the program. Consequently, the priority of the execution order is decreased in the order of the set including processes A to C, the set including processes D to F, and the set including the processes G and H. In the present embodiment, the indicator Ind corresponds to a predetermined parameter.

According to the above configuration, since the priority order can be set for the respective processes A, B and so on as in the first embodiment, the same operation and advantages as those in the first embodiment can be obtained.

### Fifth Embodiment

The following will describe a parallelization compiling method, a parallelization compiler CP, and an ECU 3 according to a fifth embodiment. Hereinafter, differences from the first embodiment will be mainly described.

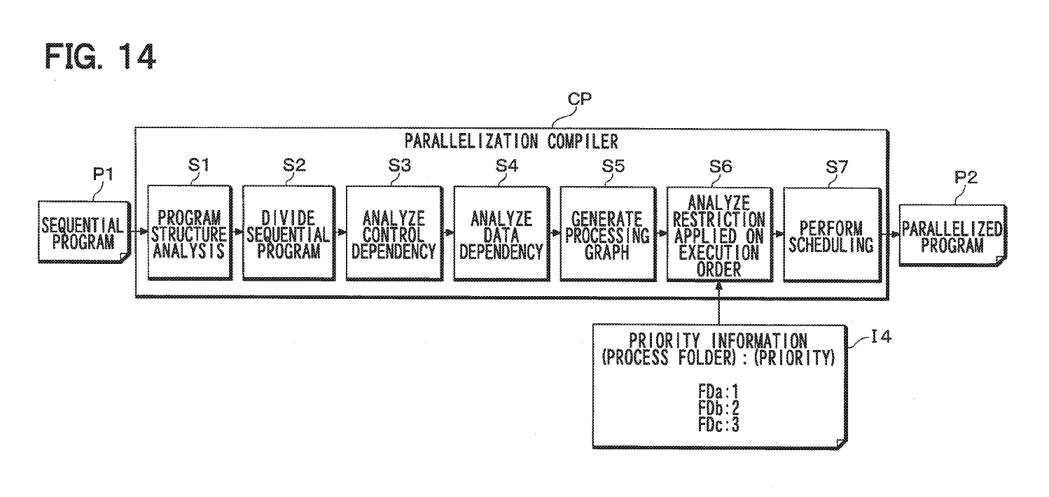

As illustrated in FIG. 14, the parallelization compiler CP according to the present embodiment analyzes, at S6, the restriction applied on an execution order of respective processes A, B and so on, on the basis of priority information I4 of respective process folders FDa, FDb and so on instead of the priority information I1 of the respective processes. A single or multiple process files may be stored in each of the process folders. A single or multiple processes may be described in each of the process files.

For example, it is assumed that the sequential program P1 includes the process folders FDa, FDb, and FDc. The process files in which the contents of the processes A to C are described are stored in the process folder FDa. The process files in which the contents of the processes D to F are described are stored in the process folder FDb. The process files in which the contents of the processes G and H are described are stored in the process folder FDc. The parallelization compiler CP executes the process files stored in the process folders FDa to FDc. In that case, for example, as illustrated in FIG. 14, the priority information I4 represents the priorities of respective process folders FDa to FDc by numerals. In the priority information I4, a smaller numeral represents a higher execution priority of the process folder. The priority information I4 may be, for example, transmitted from the input device 25 as input information, or stored in the storage medium 1 in advance. In the present embodiment, the priority information I4 corresponds to a predetermined parameter.

Subsequent to the process in S6, the parallelization compiler CP performs, at S7, scheduling for assigning the respective processes A, B and so on to multiple process groups PG1, PG2 and so on, on the basis of the processing graph MTG generated in S5 and the restriction applied on the execution order of the respective processes A, B and so on which are analyzed in S6. Specifically, the parallelization compiler CP allocates all or a part of the processes executable in the parallelizing process to the different process groups PG1, PG2 and so on while satisfying the following conditions D1 and D2.

Condition D1: The process folder having higher priority is executed prior to the process folder having lower priority.

Condition D2: A start time of the process folder having lower priority is posterior to an end time of the process folder having higher priority.

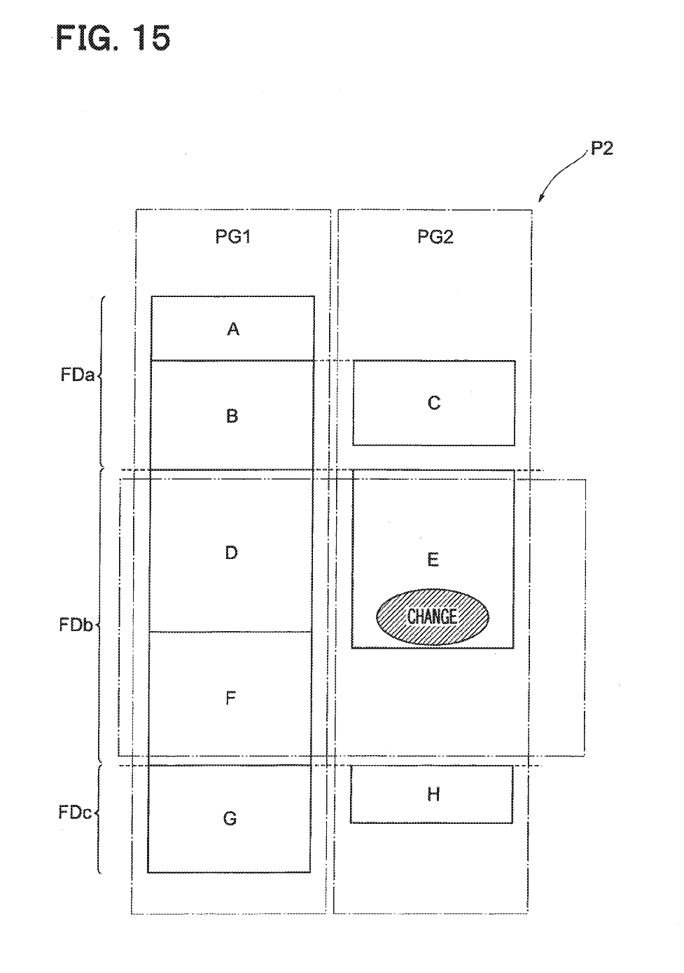

As a result, the parallelization compiler CP generates the process groups PG1 and PG2 illustrated in FIG. 15, for example, on the basis of the processing graph MTG illustrated in FIG. 5 and the priority information I4.

The following will describe the operation and advantages of the parallelization compiling method, the parallelization compiler CP, and the ECU 3 according to the present embodiment.

As illustrated in FIG. 15, even when the contents of the process E are changed, the parallelization compiler CP generates the process groups PG1 and PG2 that allow the process folder FDb to be executed after the execution of the process folder FDa has been completed by the aid of the priority information I4. The parallelization compiler CP generates the process groups PG1 and PG2 that allow the process folder FDc to be executed after the execution of the process folder FDb has been completed. Therefore, the change in the process E merely affects a region indicated by a two-dot chain line in the FIG. 15, that is, a local extent of a parallelized program P2. Hence, similar advantages as those in the first embodiment can be obtained.

### Sixth Embodiment

The following will describe a parallelization compiling method, a parallelization compiler CP, and an ECU 3 according to a sixth embodiment. Hereinafter, differences from the first embodiment will be mainly described.

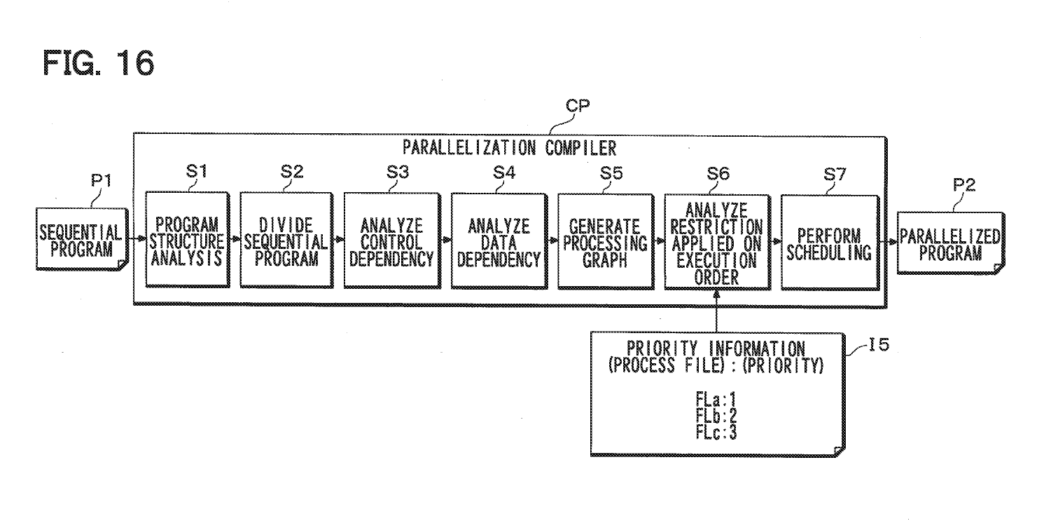

As illustrated in FIG. 16, the parallelization compiler CP according to the present embodiment analyzes, at S6, the restriction applied to an execution order of respective processes A, B and so on, on the basis of priority information I5 of respective process files FLa, FLb and so on instead of priority information I1 of the processes. A single or multiple processes may be described in each of the process files.

For example, it is assumed that a sequential program P1 includes the processing files FLa, FLb, and FLc. The contents of the processes A to C are described in the process file FLa. The contents of the processes D to F are described in the process file FLb. The contents of the processes G and H are described in the process file FLc. The parallelization compiler CP executes the processes stored in the process files FLa to FLc. In that case, for example, as illustrated in FIG. 16, priority information I5 represents the priorities of the process files FLa to FLc by numerals. In the priority information I5, a smaller numeral represents a higher execution priority of the process in the process file. The priority information I5 may be, for example, transmitted from the input device 25 as input information, or may be stored in the storage medium 1 in advance. In the present embodiment, the priority information I5 corresponds to a predetermined parameter.

Subsequent to the process in S6, the parallelization compiler CP performs, at S7, scheduling for assigning the respective processes A, B and so on to multiple process groups PG1, PG2 and so on, on the basis of the processing graph MTG generated in S5 and the restriction applied on the execution order of the respective processes A, B and so on which are analyzed in S6. Specifically, the parallelization compiler CP allocates all or a part of the processes executable in the parallelizing process to the different process groups PG1, PG2 and so on while satisfying the following conditions E1 and E2.

Condition E1: The process file having higher priority is executed prior to the process file having lower priority.

Condition E2: A start time of the process file having lower priority is posterior to an end time of the process file having higher priority.

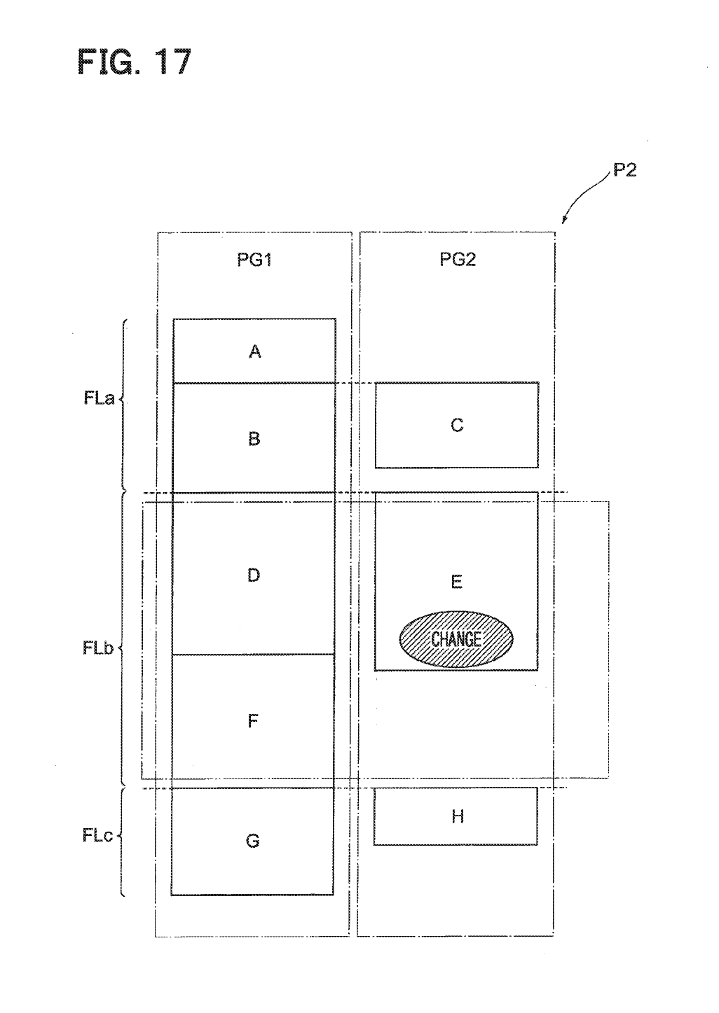

As a result, the parallelization compiler CP generates the process groups PG1 and PG2 illustrated in FIG. 17, for example, on the basis of the processing graph MTG illustrated in FIG. 5 and the priority information I5.

The following will describe operation and advantages of the parallelization compiling method, the parallelization compiler CP, and the ECU 3 according to the present embodiment.

As illustrated in FIG. 17, even when the contents of the process E are changed, the parallelization compiler CP generates the process groups PG1 and PG2 that allow the process file FLb to be executed after the execution of the process file FLa has been completed by the aid of priority information I5. The parallelization compiler CP generates the process groups PG1 and PG2 that allow the process file FLc to be executed after the execution of the process file FLb has been completed. Therefore, the change in the process E merely affects a region indicated by a two-dot chain line in the FIG. 17, that is, a local extent of a parallelized program P2. Hence, similar advantages as those in the first embodiment can be obtained.

### Other Embodiments

The above-described embodiments may also be implemented by the following configurations.

The parallelization compiler CP according to the first embodiment may employ the following condition B3 instead of the condition B2 for performing scheduling at S7.

Condition B3: A start time of the process having lower priority is posterior to a start time of the process having higher priority.

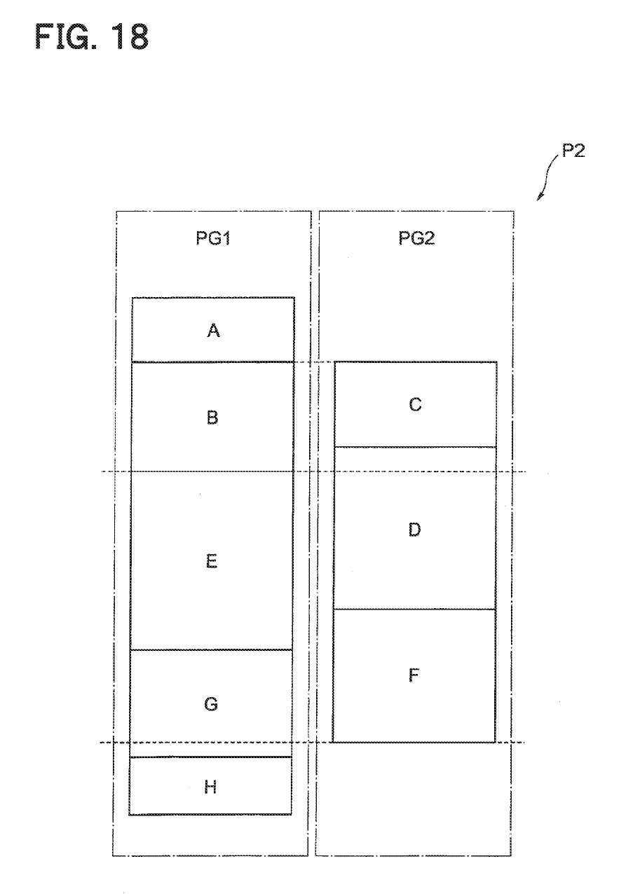

Based on the above condition, the parallelization compiler CP can generate process groups PG1 and PG2 illustrated in FIG. 18, for example, on the basis of the processing graph MTG illustrated in FIG. 5 and the priority information I1. Thus, an execution time of a parallelized program P2 can be reduced. The condition C2 in the third embodiment, the condition D2 in the fifth embodiment, and the condition E2 in the sixth embodiment may be changed in similar manner.

The indicator Ind according to the fourth embodiment may add a dependency of the prior and posterior processes in a sequential program P1. Even with the above configuration, similar operation and similar advantages as those in the fourth embodiment can be obtained,

The parallelization compiler CP may be installed into a compiling device 2 through a network.

The compiling device 2 is not limited to the vehicular device, but can be used in the development of a parallelized program for a built-in system intended for various applications such as information appliances, or the development of a parallelized program for other applications aside from the built-in system. According to the foregoing embodiments, the compiling is performed in a state where the execution order of the multiple processes is restricted in changing any one of the multiple processes. Thus, an influence of a change in the process is restricted to a local extent corresponding to the restriction applied on the execution order. In other words, the change in the process merely affects the local extent of the parallelized program without affecting the overall parallelized program. Hence, because only the local extent of the parallelized program has only to be verified, the verification of the program is facilitated.

Further, according to the foregoing embodiments of the present disclosure, the parallelized program can be easily verified in a case where a program change is made.

In the present disclosure, it is noted that a flowchart or the processing of the flowchart in the present disclosure includes sections (also referred to as steps), each of which is represented, for instance, as S1. Further, each section can be divided into several sub-sections while several sections can be combined into a single section. Furthermore, each of thus configured sections can be also referred to as a circuit, device, module, or means.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. A parallelization compiling method comprising:
analyzing a sequential program prepared for a single-core processor;
dividing the sequential program into a plurality of processes based on an analysis result; and
generating a parallelized program, which is subjected to a parallelized execution by a multi-core processor, from the plurality of processes, wherein the generating of the parallelized program includes compiling the plurality of processes under an execution order restriction defined based on a predetermined parameter.

2. The parallelization compiling method according to claim 1, wherein
the predetermined parameter is provided by priorities of the plurality of processes.

3. The parallelization compiling method according to claim 1, wherein
the predetermined parameter is provided by a dependent relationship of the plurality of processes.

4. The parallelization compiling method according to claim 1, wherein
the sequential program includes one or more function blocks,
each of the one or more function blocks includes one or more of the plurality of processes, and
the predetermined parameter is provided by priorities respectively set for the one or more function blocks.

5. The parallelization compiling method according to claim 1, wherein
the sequential program includes one or more indicators,
each of the one or more indicators is defined for changing an execution priority of two or more of the plurality of processes arranged prior and posterior in the sequential program or defined for adding a dependent relationship of the two or more of the plurality of processes arranged prior and posterior in the sequential program, and
the predetermined parameter is provided by the one or more indicators.

6. The parallelization compiling method according to claim 1, wherein
the sequential program includes one or more folders,
each of the one or more folders includes one or more files,
each of the one or more files includes one or more of the plurality of processes, and
the predetermined parameter is provided by priorities of the one or more folders.

7. The parallelization compiling method according to claim 1, wherein
the sequential program includes one or more files,
each of the one or more files includes one or more of the plurality of processes, and
the predetermined parameter is provided by priorities of the one or more files.

8. A parallelization compiler stored in a non-transitory tangible computer readable storage medium as a program product, the parallelization compiler comprising instructions to be executed by a compiling device, the instructions for implementing:
analyzing a sequential program prepared for a single-core processor;
dividing the sequential program into a plurality of processes based on an analysis result; and
generating a parallelized program, which is subjected to a parallelized execution by a multi-core processor, from the plurality of processes, wherein the generating of the parallelized program includes compiling the plurality of processes under an execution order restriction defined based on a predetermined parameter.

9. The parallelization compiler according to claim 8, wherein
the predetermined parameter is provided by priorities of the plurality of processes.

10. The parallelization compiler according to claim 8, wherein
the predetermined parameter is provided by a dependent relationship of the plurality of processes.

11. The parallelization compiler according to claim 8, wherein
the sequential program includes one or more function blocks,
each of the one or more function blocks includes one or more of the plurality of processes, and
the predetermined parameter is provided by priorities respectively set for the one or more function blocks.

12. The parallelization compiler according to claim 8, wherein
the sequential program includes one or more indicators,
each of the one or more indicators is defined for changing an execution priority of two or more of the plurality of processes arranged prior and posterior in the sequential program or defined for adding a dependent relationship of the two or more of the plurality of processes arranged prior and posterior in the sequential program, and
the predetermined parameter is provided by the one or more indicators.

13. The parallelization compiler according to claim 8, wherein
the sequential program includes one or more folders,
each of the one or more folders includes one or more files,
each of the one or more files includes one or more of the plurality of processes, and
the predetermined parameter is provided by priorities of the one or more folders.

14. The parallelization compiler according to claim 8, wherein
the sequential program includes one or more files,
each of the one or more files includes one or more of the plurality of processes, and
the predetermined parameter is provided by priorities of the one or more files.

15. A vehicular device comprising:
a multi-core processor performing a control process based on the parallelized program generated by the parallelization compiling method according to claim 1.

16. A vehicular device comprising:
a multi-core processor performing a control process based on the parallelized program generated by the parallelization compiler according to claim 8.
